(19) United States
(12) Patent Application Publication
(10) Pub. No.: US 2009/0091488 A1
(43) Pub. Date: Apr. 9, 2009

(54) INPUT DEVICE AND REMOTE-CONTROL TRANSMITTER USING THE SAME

(76) Inventor: Shigeru Shibutani, Fukui (JP)

Correspondence Address: WENDEROTH, LIND & PONACK L.L.P., 2033 K. STREET, NW, SUITE 800, WASHINGTON, DC, 20006, US

(21) Appl. No.: 12/240,055

(22) Filed: Sep. 29, 2008

(30) Foreign Application Priority Data
Oct. 9, 2007 (JP) 2007-263087

(51) Int. Cl. H04L 17/02

(52) U.S. Cl. 341/176

(57) ABSTRACT

The input device has a fixed board and a movable board, which face with each other at established intervals. The fixed board has lower fixed-electrodes and upper fixed-electrodes, each of which has a band shape, in an orthogonal arrangement on the upper surface. The movable board has a movable electrode on all over the lower surface. Power is supplied to the lower-fixed electrodes and the upper fixed-electrodes only; the movable electrode is in no need of power supply, and therefore movable electrode 24 has no need for being connected to the fixed board and the controller. This eliminates a connector, providing a cost-reduced remote-control transmitter with a simple structure.

### FIELD OF THE INVENTION

The present invention relates to an input device for operation of various electronic devices and a remote-control transmitter using the input device.

### BACKGROUND ART

As an electronic device, such as a TV, video cassette recorder (VCR) and air conditioner, expands its capability and variety, low price and ease-of-use features are demanded of an input device and a remote-control transmitter that operate such an advanced electronic device.

FIG. 9 is a sectional view of a conventional remote-control transmitter. FIG. 10 is an exploded perspective view of the transmitter. In FIGS. 9 and 10, box-shaped upper case 1 is made of insulating resin, and operation body 2 is made of rubber or elastomer. In the right of the upper surface of upper case 1, a plurality of domed operational sections 2A protrude through a plurality of through-holes 1A so as to be movable in the vertical direction. Film-like movable board 3 has a plurality of band-shaped movable electrodes 4 on the lower surface. Movable electrodes 4 are made of carbon or the like. Movable board 3 is attached to opening hole 1B formed in the left of the upper surface of upper case 1.

Fixed board 5 has a plurality of wiring patterns (not shown) on both surfaces. In the right of the upper surface of fixed board 5, a plurality of fixed contacts 6 is formed, and in the left of the upper surface, a plurality of band-shaped fixed electrodes 7 is formed so as to be orthogonal to movable electrodes 4. Fixed contacts 6 and fixed electrodes 7 are made of carbon or the like.

Frame-shaped spacer 8 has adhesive layers (not shown) coated on the both surfaces. Movable board 3 and fixed board 5 are attached by the adhesive layers so that movable electrodes 4 on the lower surface of movable board 3 face fixed electrodes 7 on the upper surface of fixed board 5 at established intervals. Input device 9 is thus completed.

Operation body 2 is mounted on the right of the upper surface of fixed board 5. Movable contacts 10, which are made of carbon or the like and disposed under each of operational sections 2A, face fixed contacts 6 on the upper surface of fixed board 5 at established intervals.

Fixed board 5 has connector 11 on the upper surface. Tail 3A, which is extended from movable electrodes 4 on movable board 3, is connected to connector 11. In addition, transmitter 12 having an LED and the like, and controller 13 having a microcomputer and the like are disposed on each surface of fixed board 5.

Transmitter 12, fixed contacts 6, fixed electrodes 7 and movable electrodes 4 are electrically connected to controller 13 via the wiring patterns and connector 11. The lower surface of upper case 1 is covered with insulating resin-made lower case 14. The remote-control transmitter is thus completed.

Such structured remote-control transmitter allows a user to control an electronic device at a distance through the following process. When a user points the remote-control transmitter toward the electronic device and pushes a certain position of operational sections 2A with finger operation, the position lowers down and one of movable contacts 10 disposed under the pushed position makes a contact with corresponding one of fixed contacts 6. As the user operates operational sections 2A, some of fixed contacts 6 have electrical connections via movable contacts 10. Controller 13 detects the electrical connections of fixed contacts 6 and requests transmitter 12 to transmit an infrared remote-control signal to the electronic device. Receiving the remote-control signal, a remote-control receiver built in the electronic device carries out operations according to the signal, for example, turning on/off, tuning channels, and controlling a sound level of a TV or VCR.

Besides, under the condition where the display, such as an LCD, of the electronic device shows a broadcast program menu, when the user pushes a certain part on the upper surface of movable board 3 of input device 9 by finger operation, movable board 3 disposed under the pushed part lowers down and makes contact with fixed electrodes 7. Through the operation, movable electrodes 4 and fixed electrodes 7 sequentially undergo application of voltage. According to voltage difference between the electrodes, controller 13 detects the pushed position and transmits the position data to the electronic device as an infrared remote-control signal. Receiving the remote-control signal, a remote-control receiver built in the electronic device carries out operations according to the signal, for example, moving the cursor shown on the display in the vertical and horizontal directions. Through the operation, the user selects a desired program from the menu.

According to the structure of input device 9, pushing operations onto operational sections 2A allows fixed contacts 6 to have electrical connections via movable contacts 10, providing typical remote control on the electronic device, such as turning on/off, tuning channels, and controlling a sound level. At the same time, pushing operations onto movable board 3 of input device 9 allows movable electrodes 4 and fixed electrodes 7 to have electrical connections, so that the user selects a desired program from the menu by moving the cursor on the display.

For example, Japanese Unexamined Patent Application Publication No. 2006-33680 is a well-known patent document relating to the structure described above.

However, there is a problem in the aforementioned conventional input device and the remote-control transmitter using the device. That is, input device 9 has a structure where movable board 3 having movable electrodes 4 on the lower surface faces fixed board 5 having fixed electrodes 7 on the upper surface at established intervals. There is a need for supplying power to movable electrodes 4, as well as to fixed electrodes 7. Therefore, the input device needs connector 11 for connecting tail 3A of movable board 3, which contributes to a complicated structure of an input device with increase in cost and parts count.

### SUMMARY OF THE INVENTION

The present invention provides an input device with a simple structure and a cost-reduced remote-control transmitter with a variety of operations.

The input device of the present invention has a fixed board and a movable board, which face with each other at established intervals. The fixed board has a plurality of band-shaped fixed electrodes in an orthogonal arrangement on the upper surface. On the other hand, the movable board has a movable electrode on all over the lower surface. Power is supplied to the fixed electrodes only; the movable electrode is in no need of power supply, and therefore the movable electrode has no need for being connected to the fixed board and the controller. This eliminates a connector, providing a cost-reduced input device with a simple structure.

According to the remote-control transmitter of the present invention, the controller is connected to the fixed electrodes of the input device. Responding to the electrical connections between the fixed electrodes, the controller requests the transmitter to transmit a remote-control signal. The structure above contributes to a cost-reduced remote-control transmitter with a variety of operations.

### BRIEF DESCRIPTION OF THE DRAWINGS

FIG. 1 is a sectional view of a remote-control transmitter in accordance with an exemplary embodiment of the present invention.

FIG. 2 is an exploded perspective view of the remote-control transmitter in accordance with the exemplary embodiment.

FIG. 3 is a partially perspective view of the remote-control transmitter in accordance with the exemplary embodiment.

FIG. 4A is a partially sectional view of the remote-control transmitter in accordance with the exemplary embodiment.

FIG. 4B is a partially sectional view of the remote-control transmitter in a state where a pushing force is applied onto the remote-control transmitter.

FIG. 5 is a front view of an electronic device.

FIG. 6 is a partially exploded perspective view of another remote-control transmitter in accordance with the exemplary embodiment.

FIG. 7 is a partially exploded perspective view of still another remote-control transmitter in accordance with the exemplary embodiment.

FIG. 8 is a partially exploded perspective view of yet another remote-control transmitter in accordance with the exemplary embodiment.

FIG. 9 is a sectional view of a conventional remote-control transmitter.

FIG. 10 is an exploded perspective view of the conventional remote-control transmitter.

### DETAILED DESCRIPTION OF THE INVENTION

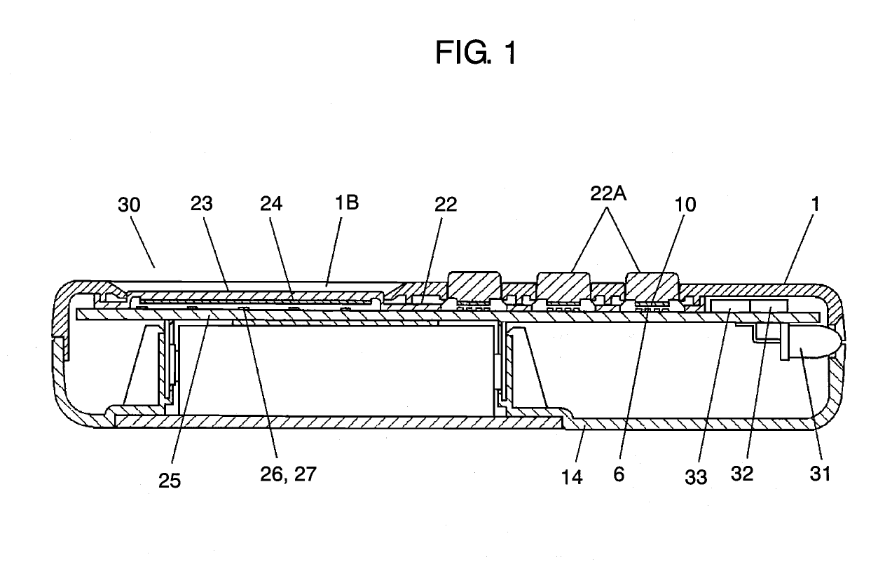

An exemplary embodiment of the present invention is described hereinafter with reference to the accompanying drawings, FIG. 1 through FIG. 8. Throughout the drawings, the parts substantially the same as those described in Background Art have similar reference marks and a detailed description thereof will be omitted.

### Exemplary Embodiment

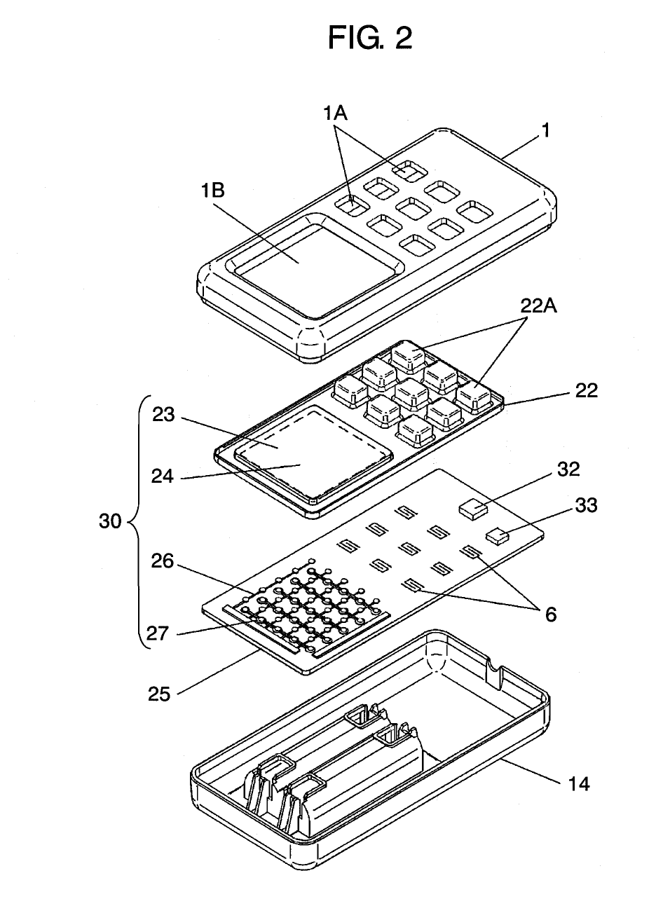

FIG. 1 is a sectional view of a remote-control transmitter in accordance with the exemplary embodiment of the present invention. FIG. 2 is an exploded perspective view of the remote-control transmitter. Box-shaped upper case 1 is made of insulating resin, such as polystyrene or acrylonitrile butadiene styrene (ABS). Operation body 22 is made of rubber or elastomer. A plurality of domed operational sections 22A is disposed on the upper surface of operation body 22. In the right of the upper surface of upper case 1, operational sections 22A protrude through a plurality of through-holes 1A so as to be movable in the vertical direction.

Movable board 23 is integrally formed with operation body 22. Movable board 23 is connected, by the thin-structured section formed in the periphery of the lower surface of movable board 23, to the left of the upper surface of operation body 22. Movable electrode 24, which is made of carbon or the like, is formed all over the lower surface of movable board 23. Such structured movable board 23 is attached to opening hole 1B formed in the left of the upper surface of upper case 1.

Fixed board 25 of a plate shape is made of a paper phenol resin or a glass epoxy resin. A plurality of wiring patterns (not shown) is formed, with the use of copper foil, on both the surfaces of fixed board 25. In the right of the upper surface of fixed board 25, a plurality of carbon-made fixed contacts 6 is formed, and in the left of the upper surface, a plurality of lower fixed-electrodes 26 and upper fixed-electrodes 27, each of which is formed into a band shape, are formed in an orthogonal arrangement.

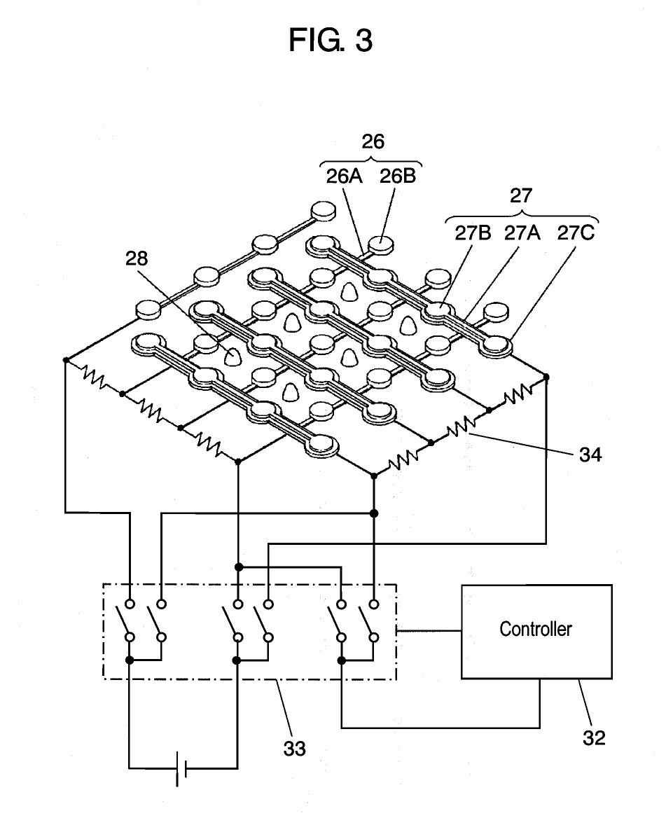

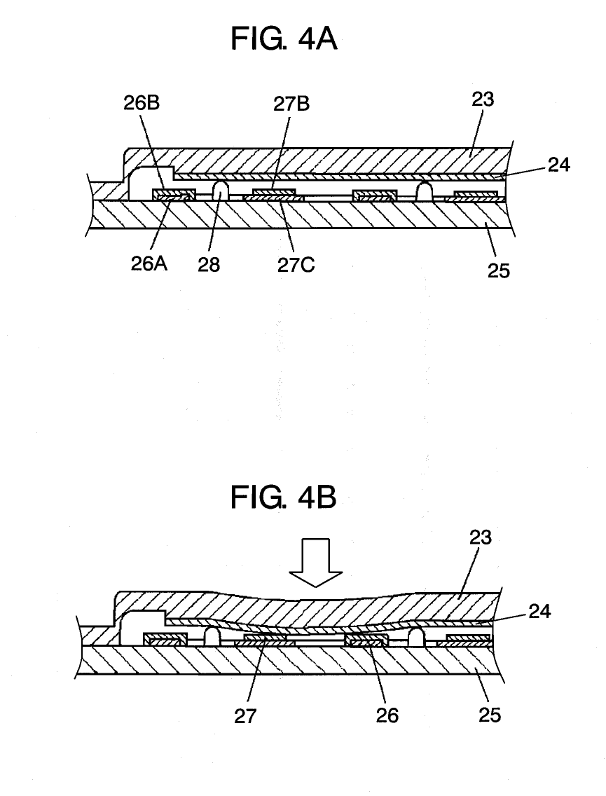

FIG. 3 is a partially perspective view and FIG. 4A is a partially sectional view of the remote-control transmitter in accordance with the exemplary embodiment. As shown in FIGS. 3 and 4A, carbon-made circular pieces 26B are spaced on copper-foil beam 26A, which forms a plurality of lower fixed-electrodes 26. Insulating layer 27C, which is made of polyester, epoxy, or the like, is formed orthogonal to lower fixed-electrodes 26. On insulating layer 27C, carbon-made circular pieces 27B are spaced on carbon beams 27A, which forms a plurality of upper fixed-electrodes 27.

Besides, dotspacers 28, which are made of epoxy or silicone, are formed on the upper surface of fixed board 25.

Operation body 22 is mounted on the upper surface of fixed board 25, so that carbon-made movable contact 10, which is formed under operational sections 22A, faces fixed contacts 6 disposed on the upper surface of fixed board 25 at established intervals. At the same time, movable electrode 24 on the lower surface of movable board 23 faces, at established intervals, lower fixed-electrodes 26 and upper fixed-electrodes 27 on the upper surface of fixed board 25. Input device 30 is thus completed.

In addition, transmitter 31 having an LED, and controller 32 having a microcomputer, and switching section 33 are disposed on each surface of fixed board 25. Transmitter 31, switching section 33, fixed contacts 6, lower fixed-electrodes 26, and upper fixed-electrodes 27 are electrically connected to controller 32 via the wiring patterns. The lower surface of upper case 1 is covered with insulating resin-made lower case 14.

A plurality of resistors 34 is formed at each end of lower fixed-electrodes 26 and upper fixed-electrodes 27. Resistors 34 may be an actually mounted fixed resistor or a printed resistor. Each end of resistors 34 is connected to switching section 33. Controller 32 detects voltage ratio between lower fixed-electrodes 26 and upper fixed-electrodes 27.

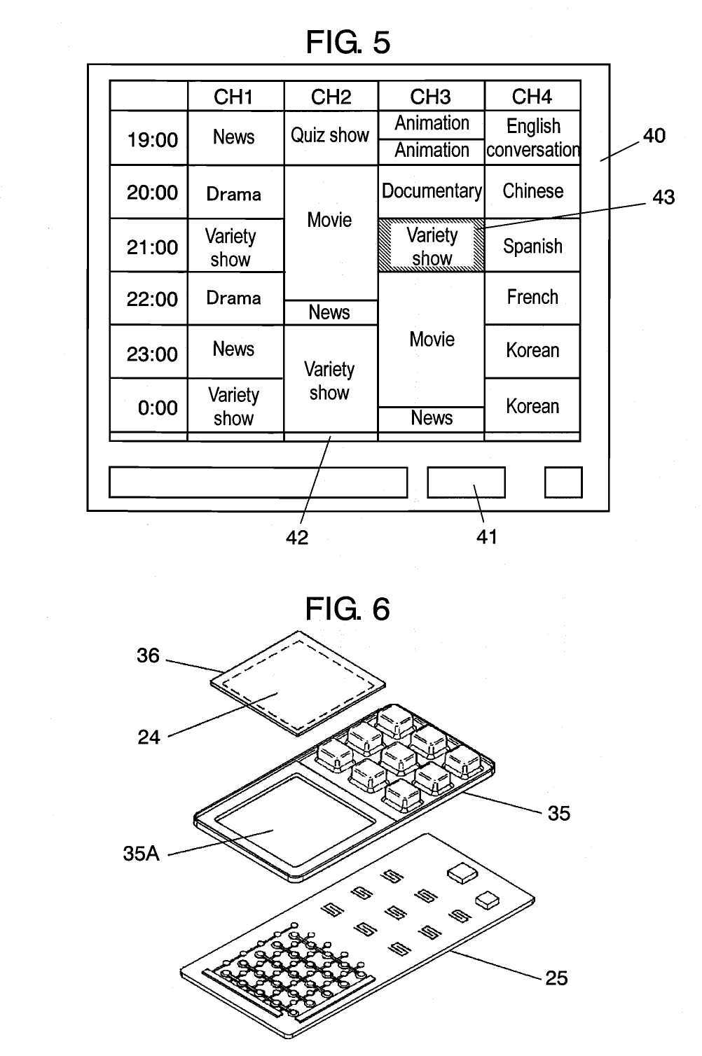

FIG. 4B is a partially sectional view of the remote-control transmitter in a state where a pushing force is applied onto the remote-control transmitter. FIG. 5 is a front view of an electronic device. FIGS. 4B and 5 illustrate that application of pushing force to the remote-control transmitter allows the user to select a desired program from the program menu shown on the display. Hereinafter will be described the workings of the remote-control transmitter.

The remote-control transmitter and remote-control receiver 41 constitute a remote-control communications unit. Receiving a remote-control signal from the transmitter, receiver 41 carries out various operations of electronic device 40. When the user points the remote-control transmitter toward the electronic device and pushes a certain position of operational sections 22A with finger operation, the position lowers down and one of movable contacts 10 disposed under the pushed position makes a contact with corresponding one of fixed contacts 6. As the user operates operational sections 22A, some of fixed contacts 6 have electrical connections via movable contacts 10. Controller 32 detects the electrical connections of fixed contacts 6 and requests transmitter 31 to transmit an infrared remote-control signal to the electronic device. Receiving the remote-control signal, remote-control receiver 41 built in the electronic device carries out operations according to the signal, for example, turning on/off, tuning channels, and controlling a sound level of a TV or VCR.

In addition, under the condition where a broadcast program menu appears on display 42, which may be an LCD, of electronic device 40, when the user pushes a certain part, or gives a “push-and-drag” motion on the upper surface of movable board 23 of input device 30, movable board 23 disposed under the pushed part lowers down, by which movable electrode 24 makes contact with lower fixed-electrode 26 and upper fixed-electrodes 27 (FIG. 4B). At this time, controller 32 operates switching section 33 so that voltage is sequentially applied to lower fixed-electrodes 26 and upper fixed-electrodes 27. According to voltage difference between the electrodes, controller 32 detects the position at which the electrical connection is established by lower fixed-electrodes 26 and upper fixed-electrodes 27 via movable electrode 24, and transmits the position data to electronic device 40 as an infrared remote-control signal. Receiving the remote-control signal, remote-control receiver 41 built in electronic device 40 carries out operations according to the signal, for example, moving cursor 43 shown on display 42 in the vertical and horizontal directions. Through the operation, the user selects a desired program from the menu.

As described above, applying pushing force onto operational sections 22A establishes electrical connections between fixed contacts 6 via movable contacts 10. This allows the user to have typical remote-control operations on electronic device 40, for example, turning on/off, tuning channels, and controlling a sound level. Besides, applying pushing force onto movable board 23 of input device 30 establishes electrical connections between movable electrode 24 and lower fixed-electrodes 26 and upper fixed-electrodes 27. This allows the user to move cursor 43 shown on display 42 and to select a desired program from a broadcasting program menu.

In input device 30 used for menu selection, as described above, fixed board 25 faces movable board 23 at established intervals. A plurality of lower fixed-electrodes 26 and a plurality of upper fixed-electrodes 27, each of which has a band shape, are disposed in an orthogonal arrangement on the upper surface of fixed board 25. Movable electrode 24 is disposed all over the lower surface of movable board 23. In such structured input device 30, electric power is supplied to lower fixed-electrodes 26 and upper fixed-electrodes 27 only; movable electrode 24 has no power supply.

That is, movable electrode 24 lowered down by a pushing force allows lower fixed-electrodes 26 and upper fixed-electrodes 27 close to the pushed position to have electrical connections. There is no need for supplying power to movable electrode 24 disposed above fixed board 25. That is, the structure eliminates a connector used for connecting movable electrode 24 to fixed board 25 and controller 32, providing cost-reduced input device 30 with a simple structure.

FIG. 6 is a partially exploded perspective view of another remote-control transmitter in accordance with the embodiment. Although the description above introduces the structure where movable board 23 is integrally formed in the left of operation body 22 having operational sections 22A, it is not limited to. In the structure shown in FIG. 6, movable board 36, which is made of flexible film of, for example, polyethylene terephthalate, polycarbonate, polyimide, is formed separately from operation body 35. Carbon-made movable electrode 24 is formed all over the lower surface of movable board 36. Such structured movable board 36 is attached on opening hole 35A of operation body 35, and which is further mounted on fixed board 25. The structure above is also effective in providing advantages of the embodiment.

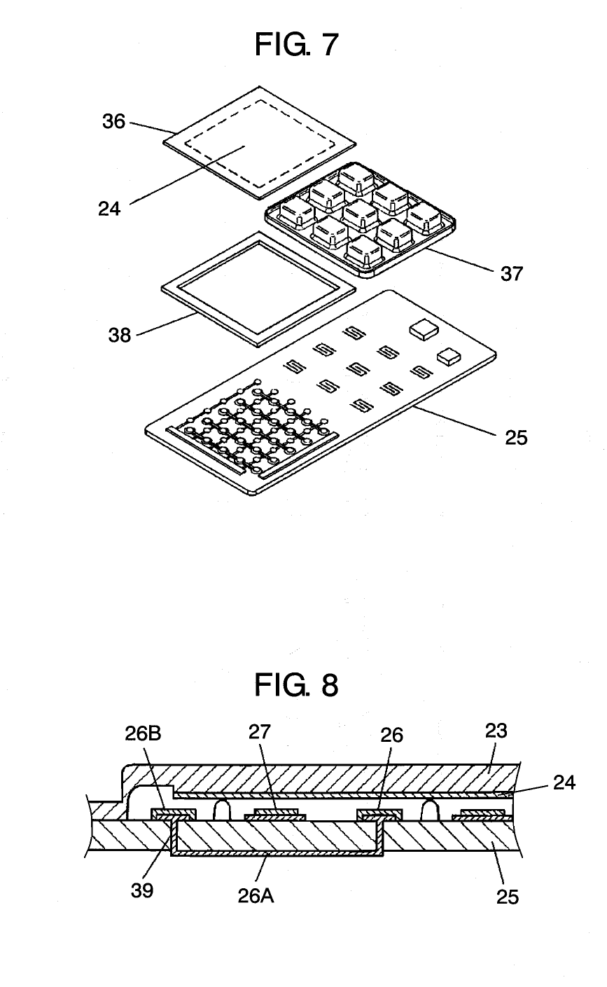

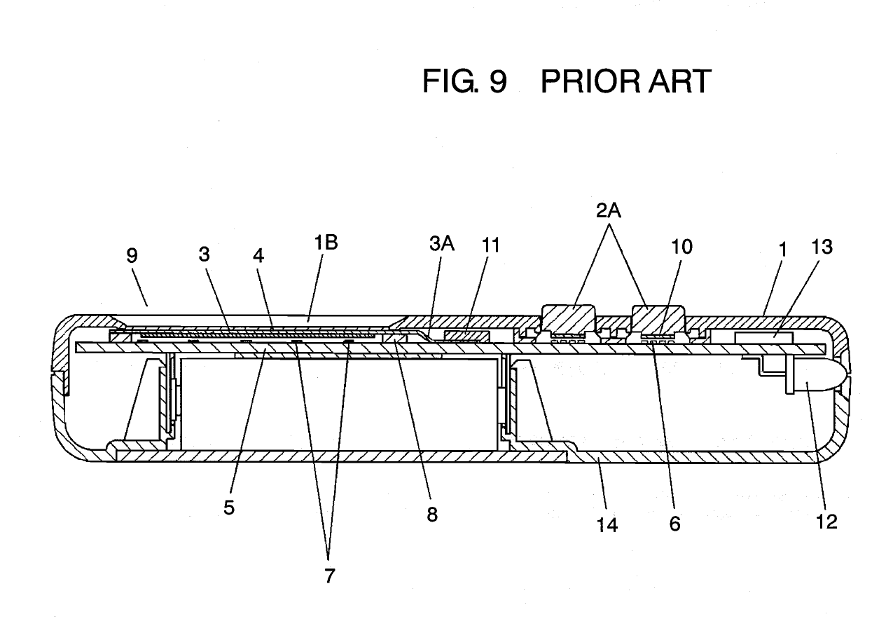

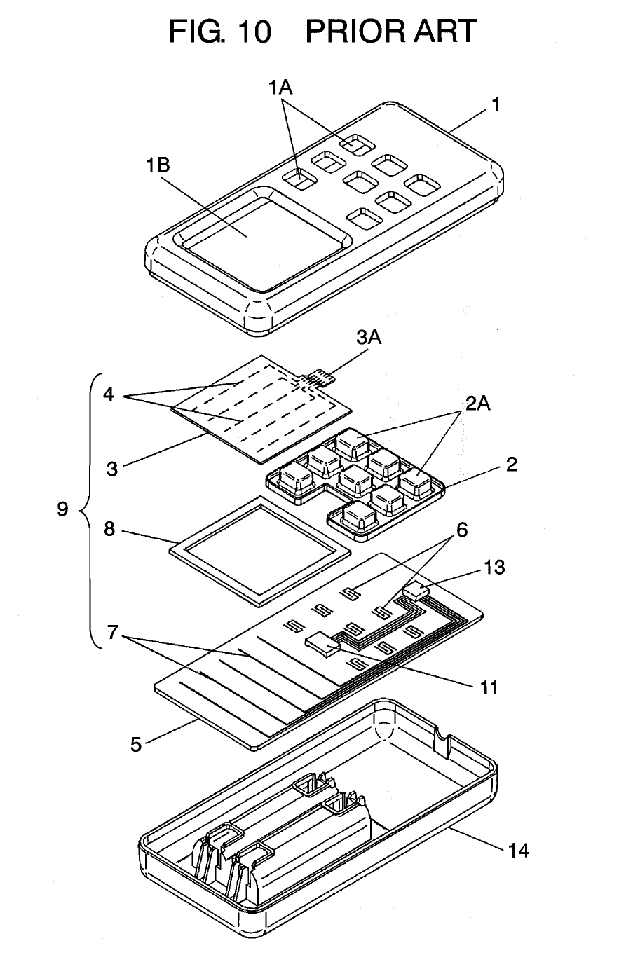

FIG. 7 is a partially exploded perspective view of still another remote-control transmitter in accordance with the embodiment. In the structure shown in FIG. 7, film-like movable board 36 is formed separately from operation body 37. Movable electrode 24 is formed all over the lower surface of movable board 36. Generally frame-shaped spacer 36 has adhesive layers (not shown) coated on both surfaces. Movable board 36 is attached to fixed board 25 via spacer 38 to be located in the left of fixed board 25.

FIG. 8 is a partially exploded perspective view of yet another remote-control transmitter in accordance with the exemplary embodiment. Although the foregoing description introduces the structure where lower fixed-electrodes 26 are disposed orthogonal to upper fixed-electrodes 27, with a part of the upper and lower electrodes overlapped, FIG. 8 shows another possibility. In addition to lower fixed-electrodes 26 and upper fixed-electrodes 27, fixed board 25 of FIG. 8 has silver-filled through-hole 39 and beam 26A that is formed on the lower surface of fixed board 25 and connects between circular pieces 26B.

Input device 30 of the present invention has fixed board 25 and movable board 23, which face with each other at established intervals. Fixed board 25 has a plurality of lower fixed-electrodes 26 and a plurality of upper fixed-electrodes 27, each of which has a band shape, in an orthogonal arrangement on the upper surface. On the other hand, movable board 23 has movable electrode 24 on all over the lower surface. Power is supplied to fixed electrodes 26, 27 only; movable electrode 24 is in no need of power supply, and therefore movable electrode 24 has no need for being connected to the fixed board and the controller. This eliminates a connector, providing a cost-reduced input device with a simple structure.

According to the remote-control transmitter of the present invention, controller 32 is connected to lower fixed-electrodes 26 and upper fixed-electrodes 27 of input device 30. According to a state of electrical connections between lower fixed-electrodes 26 and upper fixed-electrodes 27, controller 32 requests transmitter 31 to transmit a remote-control signal. The structure above contributes to a cost-reduced remote-control transmitter with a variety of operations.

The description above is given on an example where the user selects a desired broadcasting program from the menu shown on the display of the electronic device. Specifically, when a broadcasting menu appears on display 42 of electronic device 40, application of pushing force onto movable board 23 of input device 30 allows cursor 43 to move in a direction on display 42, so that the user selects desired one from the menu. Instead of the broadcasting program menu, display 42 may show program information, a tune list, or map information. Similarly, instead of cursor 43, display 42 may show an arrow- or finger-shaped pointer.

The input device and the remote-control transmitter using the device of the present invention offer a cost-reduced structure with variety of operations. It is particularly useful for operating various electronic devices.

What is claimed is:

1. An input device comprising:
a fixed board comprising a plurality of band-shaped fixed electrodes in an orthogonal arrangement on an upper surface thereof, and
a movable board comprising a movable electrode on all over a lower surface thereof, the movable electrode facing the fixed electrodes at established intervals.

2. A remote-control transmitter comprising:
an input device of claim 1;
a controller connected to the fixed electrodes of the input device; and
a transmitter,
wherein, according to a state of electrical connections between the fixed electrodes, the controller requests the transmitter to transmit a remote-control signal.
